(19) United States
(12) Patent Application Publication
(10) Pub. No.: US 2026/0307141 A1
(43) Pub. Date: Oct. 8, 2026

(54) LITHIUM METAL POWDER, LITHIUM METAL ANODE, LITHIUM ION BATTERY, AND PREPARATION METHODS THEREOF

(71) Applicants: XI'AN TECHNOLOGICAL UNIVERSITY, Xi'an, Shaanxi (CN); ZHEJIANG UNIVERSITY, Hangzhou, Zhejiang (CN)

(72) Inventors: Hongge PAN, Xi'an, Shaanxi (CN); Mingxi GAO, Hangzhou, Zhejiang (CN); Mingxia GAO, Hangzhou, Zhejiang (CN); Wenping SUN, Hangzhou, Zhejiang (CN); Xin ZHANG, Hangzhou, Zhejiang (CN)

(21) Appl. No.: 19/146,360

(22) PCT Filed: Jan. 3, 2025
(86) PCT No.: PCT/CN2025/070432

§ 371 Date: Jul. 8, 2025

(30) Foreign Application Priority Data
Feb. 6, 2024 (CN) 202410166669.1

(51) Int. Cl. B22F 1/10; B22F 9/04; H01M 4/02; H01M 4/04; H01M 4/134; H01M 10/0525; H01M 10/0567

(52) U.S. Cl. CPC B22F 1/10; B22F 9/04; H01M 4/043; H01M 4/134; H01M 10/0525; H01M 10/0567; B22F 2009/042; B22F 2009/043; B22F 2009/049; B22F 2201/10; B22F 2202/03; B22F 2301/054; B22F 2302/45; H01M 2004/027

(57) ABSTRACT

Provided are a method for preparing a lithium metal powder and a product thereof, as well as a prepared lithium metal anode and a liquid electrolyte-based lithium ion battery and a solid electrolyte-based lithium ion battery finally assembled. The method for preparing the lithium metal powder includes: mixing a lithium metal raw material and a polymer additive to obtain a mixture, and subjecting the mixture to cryogenic ball milling under an inert gas atmosphere. The polymer additive does not react with the lithium metal raw material, and has a Rockwell hardness of 70 to 110.

The present application claims priority to Chinese Patent Application No. CN202410166669.1 filed with the China National Intellectual Property Administration (CNIPA) on Feb. 6, 2024 and entitled “LITHIUM METAL POWDER, LITHIUM METAL ANODE, LITHIUM ION BATTERY, AND PREPARATION METHODS THEREOF”, which is incorporated herein by reference in its entirety.

### TECHNICAL FIELD

The present disclosure relates to the technical field of secondary batteries, and in particular to a lithium metal powder, a lithium metal anode, a lithium ion battery, and preparation methods thereof.

### BACKGROUND

With the development of science and technology and the progress of human society, the problems of energy depletion and environmental pollution have become increasingly prominent. The development of novel, efficient, and clean energy conversion and storage technologies and energy utilization methods has become a key to solving these problems and achieving sustainable development of human society. Chemical power sources are an important technical approach to alleviate energy, resource, and environmental crises, and play an important role in the social energy system. Among many chemical power sources, lithium ion batteries, which are characterized by high energy, excellent efficiency, and environmental protection, are attracting increasing attention. Applications such as new energy storage, electric vehicles, and smart grids have placed higher demands on energy density, cycle life, power density, safety, cost, and environmental friendliness of the lithium ion batteries.

Lithium has an extremely light texture (with a density of 0.53 g/cm³), high ductility, and desirable electrical conductivity. Metallic lithium has a theoretical specific capacity of up to 3,860 mAh/g, making it one of the materials with the highest theoretical specific capacity. At the same time, Li⁺/Li has a standard electrode potential of −3.04 V, the lowest among all redox couples. Therefore, the metallic lithium is a battery anode material with great application prospects. However, the problems of using metallic lithium as an anode material for lithium secondary batteries, lithium-sulfur batteries, and lithium-air batteries are also extremely obvious, mainly because the formation of lithium dendrites during lithium deposition/dissolution can puncture the separator to cause serious safety problems.

The preparation of a nano-scale lithium metal powder with uniform particle size distribution can greatly reduce a local current density of the lithium metal anode. In addition, a high specific surface area brought by the nano-scale lithium metal powder can provide abundant nucleation sites for the lithium deposition, reduce a nucleation overpotential during the lithium deposition, thereby significantly increasing a critical current density of dendrite growth and improving safety of the lithium metal anode to promote its commercial application.

However, the excellent reactivity, high viscosity, and desirable ductility of metallic lithium make it difficult to synthesize the metallic lithium powder using common methods such as mechanical crushing, and the resulting metallic lithium powder has a large particle size. There are two commonly used methods for preparing a lithium powder. One is to melt metal lithium and then disperse same in an inert hydrocarbon oil. The other is to mix the metal lithium with an ionic liquid, heat and ultrasonically crush an obtained mixture in sequence, and then conduct post-treatment to obtain metal lithium particles. Both of the two methods have the following problems. Firstly, there is a relatively high median particle size of the lithium powder particles obtained, from 500 nm to 500 μm, there is a limited increase in specific surface area of the lithium anode, and a critical current density of dendrite growth can only be increased to 10 mA/cm². The Verband der Automobilindustrie (VDA) requires that the anode of a power battery should be able to operate at a current density of (40-80) mA/cm². Accordingly, the lithium powder obtained by the above two methods obviously cannot meet the commercialization requirements of lithium metal anodes. Secondly, both of the two methods have high operating temperatures, which need to exceed a melting point of the metallic lithium; and molten metallic lithium is highly corrosive, and then places high demands on equipment. Finally, the first method requires high-boiling-point hydrocarbon oil to disperse the droplets of molten lithium, as well as low-boiling-point hydrocarbon oil to wash the lithium powder, resulting in high environmental pollution, cumbersome preparation methods, and low preparation yields; and the ionic liquid used in the second method is expensive, resulting in a high cost.

Chinese patent CN108511713A has disclosed a method for preparing a submicron lithium anode material, including: mixing a metallic lithium raw material with an ionic liquid in an inert gas or dry air atmosphere to obtain a mixture; and subjecting the mixture to cryogenic ball milling in a cryogenic medium to obtain submicron metallic lithium particles dispersed in the ionic liquid.

The method in this patent is based on a principle that metallic lithium can become brittle in a cryogenic environment, making the originally sticky and ductile metallic lithium become more brittle, such that the larger lithium particles are crushed into smaller particles through mechanical ball milling. Metal lithium has low corrosion at this treatment temperature. However, since ionic liquid is still used as a medium, the production cost is relatively high. Moreover, since the ionic liquid used is dissolved in the liquid electrolyte, a structure of the metal lithium particles can collapse during the electrochemical cycle, and the lithium particles may gradually increase in size during the long-term electrochemical cycle. In addition, the metal lithium particles obtained by the method still have a relatively high median particle size of 100 nm to 500 nm, such that there is limited improvement on the specific surface area of lithium anode and the critical current density of dendrite growth.

### SUMMARY

In view of the above problems existing in the prior art, the present disclosure provides a method for preparing a lithium metal powder. By the method, the lithium metal powder with a uniform size and a median particle size not greater than 500 nm and a minimum median particle size of 10 nm could be prepared. The method shows a low raw material cost and a simple and easy process. The lithium metal powder prepared by the method is assembled as an anode active component to obtain a lithium ion battery, which shows a high dendrite growth critical current density and an excellent electroplating/stripping cycle stability.

The present disclosure provides the following specific technical solutions:

The present disclosure provides a method for preparing a lithium metal powder, including:
mixing a lithium metal raw material and a polymer additive to obtain a mixture, and subjecting the mixture to cryogenic ball milling under an inert gas atmosphere; where
the polymer additive does not react with the lithium metal raw material, and the polymer additive has a Rockwell hardness of 70 to 110.

The present disclosure provides a simple preparation method, which does not require the addition of expensive ionic liquids that may affect electrochemical cycle stability, but only uses the polymer as an additive to play the dual roles of grinding aid and coating, thereby significantly reducing the particle size of metallic lithium. In addition, the polymer does not react with the metallic lithium and has a Rockwell hardness of 70 to 110, with a wide selection range and strong universality; moreover, no other pretreatment for the polymer and metallic lithium is required, which effectively simplifies the preparation process.

In some embodiments, the polymer additive is at least one selected from the group consisting of polymethyl methacrylate (PMMA) (Rockwell hardness 92, the same below), polypropylene (PP) (90), styrene-butadiene-styrene block copolymer (SBS) (88), acrylonitrile-butadiene-styrene copolymer (ABS) (105), polycarbonate (PC) (93), polyamide 66 (89), and polyamide 6 (82).

Experiments have found that when the polymer additive has a Rockwell hardness that is too high, such as polyformaldehyde (121), or a Rockwell hardness that is too low, such as polyethylene (60) and polytetrafluoroethylene (25), the lithium metal cannot be ground into a powder.

In some embodiments, the lithium metal raw material is powder, flake, block, or filamentary material of lithium.

In some embodiments, the cryogenic ball milling is conducted by:
pre-freezing a mixture of the lithium metal raw material and the polymer additive in a cryogenic medium, and then alternately conducting high-frequency ball milling/high-speed ball milling and low-frequency ball milling/low-speed ball milling in sequence until the cryogenic ball milling is completed; where
a mass ratio of the lithium metal raw material to the polymer additive is in a range of 1: (0.5-2.0); preferably 1:(0.7-1.5); more preferably 1:1. Too low a polymer content is not conducive to the refinement of lithium particles; while too high a polymer content is not conducive to the electrochemical performance of the obtained nano-scale lithium powder as an anode material for lithium ion batteries due to a low electronic conductivity of the polymer.

In some embodiments, the inert gas atmosphere is selected from the group consisting of a nitrogen atmosphere, a helium atmosphere, and an argon atmosphere.

In some embodiments, the cryogenic medium is one or more selected from the group consisting of liquid nitrogen, liquid helium, and liquid argon.

In some embodiments, the cryogenic ball milling is conducted at a temperature of −270° C. to −100° C., preferably −200° C. to −150° C.

In some embodiments, the pre-freezing is conducted for 10 min to 60 min.

In some embodiments, under a condition that the cryogenic ball milling is conducted by vibration ball milling, the high-frequency ball milling is conducted at a frequency of 15 Hz to 25 Hz for 2 min to 15 min; and the low-frequency ball milling is conducted at a frequency of 1 Hz to 10 Hz for 1 min to 10 min; and
under a condition that the cryogenic ball milling is conducted by planetary ball milling, the high-speed ball milling is conducted at a rotational speed of 250 rpm to 600 rpm for 5 min to 60 min; and the low-speed ball milling is conducted at a rotational speed of 30 rpm to 250 rpm for 1 min to 20 min.

In some embodiments, the cryogenic ball milling is conducted for 30 min to 90 min in total.

In some embodiments, the cryogenic ball milling is conducted at a ball-to-material ratio of (10-100):1; preferably (20-100):1; more preferably 60:1.

After the cryogenic ball milling is completed, the metallic lithium can be ground into the lithium metal powder with a median particle size less than or equal to 500 nm.

In some embodiments, under a condition that the pre-freezing is conducted for 20 min, and the high-frequency ball milling at a frequency of 20 Hz and the low-frequency ball milling at a frequency of 5 Hz are alternately conducted for 60 min in total at a ball-to-material ratio of 60:1, the lithium metal powder has a median particle size of 100 nm.

In some embodiments, ball milling at room temperature is conducted on the basis of cryogenic ball milling.

Through experiments, it has been found that by adjusting process parameters for the ball milling at the room temperature and selecting a material used for a ball mill tank, the median particle size of the lithium metal powder can be significantly reduced to as low as 10 nm.

In some embodiments, the ball milling at the room temperature is conducted by planetary ball milling at a rotational speed of 100 rpm to 400 rpm for 3 h to 30 h under a ball-to-material ratio of (50-200):1; and
a ball mill tank and milling balls for the planetary ball milling each are made of agate.

Through experiments, it has been found that the material of the ball mill tank, the ball milling speed, the ball milling time, the ball-to-material ratio, and the milling ball ratio for the planetary ball milling can affect the particle size of the lithium metal powder obtained subsequently, thereby affecting the electrochemical properties of the lithium metal powder.

Regarding the material for the ball mill tank, among the common stainless steel, tungsten carbide, zirconium oxide, and agate, the stainless steel, tungsten carbide, and zirconium oxide can bond with lithium. Moreover, the energy of ball milling may cause the lithium to continuously bond to the milling balls, making the size of the lithium increasingly larger. Only by selecting an agate material that does not bond with lithium, that is, an agate ball mill tank and agate milling balls, can the energy of ball milling be used to further refine the particle size of the lithium metal powder. Under the optimal ball milling parameters, ball mill tanks or milling balls made of the stainless steel, tungsten carbide, or zirconium oxide cannot produce lithium metal powder with a median particle size of 10 nm.

Regarding the ball-to-material ratio, in some embodiments, the cryogenic ball milling is conducted at a ball-to-material ratio of (50-150):1; more preferably 150:1. The preferred ball-to-material ratio is more conducive to reducing the median particle size of the lithium metal powder.

Regarding the milling ball ratio, experiments have found that in some embodiments, a combination of large balls (each having a diameter of 8 mm to 14 mm) accounting for 50% to 75% by mass, medium balls (each having a diameter of 1.5 mm to 6.0 mm) accounting for 20% to 40% by mass, and small balls (each having a diameter of 0.5 mm to 1.5 mm) as a balance is more conducive to obtaining the lithium metal powder with a median particle size of 10 nm.

In some embodiments, the ball milling at the room temperature is conducted at a rotational speed of 200 rpm to 400 rpm for 3 h to 20 h; more preferably at a rotational speed of 400 rpm for 6 h.

By adding the ball milling at the room temperature on the basis of the cryogenic ball milling, the median particle size of the lithium metal powder can be controlled below 100 nm, and can be as low as 10 nm.

Through further experiments, it has been revealed that if the polymer additive used during the cryogenic ball milling in the first step is replaced with an ionic liquid, the lithium metal powder with a median particle size of 10 nm cannot be prepared even if the ball milling at the room temperature is optimized.

In some embodiments, an inert solvent that does not react with the lithium or the polymer is also added during the ball milling at the room temperature, and the inert solvent is selected from the group consisting of n-hexane, cyclohexane, n-heptane, n-octane, and benzene. Through experiments, it has been found that adding the inert solvent can further increase a yield of the prepared lithium metal powder.

The present disclosure further provides a lithium metal anode, including a current collector and an anode active material layer deposited on the current collector, where the anode active material layer includes the lithium metal powder as mentioned above.

The present disclosure further provides a liquid lithium ion battery, including a cathode, an anode, and an electrolyte, where the anode adopts the lithium metal anode as mentioned above, and the anode is prepared by a process including:
cold pressing the lithium metal powder onto the current collector.

In the present disclosure, there is no special requirement for the current collector, and common types in the art are used, such as foamed copper, foamed aluminum, and foamed nickel.

In some embodiments, the cold pressing is conducted at 1 MPa to 1 GPa, preferably 100 MPa to 500 MPa.

In some embodiments, the cathode adopts the common raw material types in the art, such as lithium-rich manganese-based cathode material, layered oxide cathode material, spinel structure cathode material, and polyanion cathode material.

In some embodiments, the electrolyte includes a lithium salt and a non-aqueous solvent.

In some embodiments, the lithium salt uses common raw material types in the art, such as lithium hexafluorophosphate (LiPF₆), lithium perchlorate (LiClO₄), lithium hexafluoroarsenate (LiAsF₆), and lithium fluorohydroxysulfonate (LiC(SO₂CF₃)₃); and the non-aqueous solvent also uses common raw material types in the art, such as dimethyl carbonate (DMC), diethyl carbonate (DEC), ethyl methyl carbonate (EMC), ethylene carbonate (EC), propylene carbonate (PC), and vinylene carbonate (VC).

In some embodiments, the electrolyte further includes an electrolyte additive.

In some embodiments, the electrolyte additive is at least one selected from the group consisting of fluoroethylene carbonate (FEC), phthalocyanine, a phthalocyanine metal complex, an I₂ elementary substance, triethylsulfonium iodide, 2,2,6,6-tetramethylpiperidinooxy (TEMPO), and 2,5-di-tert-butyl-1,4-benzoquinone (DBBQ).

In some embodiments, the phthalocyanine metal complex is at least one selected from the group consisting of copper phthalocyanine, nickel phthalocyanine, cobalt phthalocyanine, manganese phthalocyanine, zinc phthalocyanine, and iron phthalocyanine.

In some embodiments, the electrolyte additive has a mass fraction of 0.01% to 10.00%, preferably 0.03% to 3.00%, more preferably 0.1% to 1.0%.

Experiments have found that the electrolyte additive can further improve the critical current density of dendrite growth and the plating/stripping cycle stability of assembled liquid lithium ion batteries.

In some embodiments, the electrolyte additive is selected from the group consisting of the FEC, TEMPO, DBBQ, and phthalocyanine metal complex.

In some embodiments, the electrolyte additive is selected from copper phthalocyanine.

The present disclosure further provides a solid lithium ion battery, including a cathode, an anode, and a solid electrolyte, where
the anode adopts the lithium metal anode as mentioned above, and the anode is prepared by a process including:
mixing raw materials including the lithium metal powder, the solid electrolyte, and a conductive agent to be uniform, and then subjecting a resulting mixture to cold pressing to obtain the anode.

In some embodiments, the solid electrolyte is a solid electrolyte stable to the lithium metal anode, preferably at least one of hydride and oxide solid electrolytes that do not react with metallic lithium; preferably selected from the group consisting of a PEO-based electrolyte, a boron hydride-based solid electrolyte, a carbon boron hydride-based solid electrolyte, a perovskite-type solid electrolyte, a lithium superion conductor (LISICON)-type solid electrolyte, a sodium superion conductor (NASICON)-type solid electrolyte, a garnet-type solid electrolyte, and a lithium phosphorus oxygen nitrogen (LiPON)-type solid electrolyte.

In the present disclosure, there is no special requirement for a type of the conductive agent, which can be selected from the commonly used types in the art, such as at least one selected from the group consisting of graphite, acetylene black, Super P, carbon nanotube, graphene, and Ketjen black.

The raw materials can be mixed by ball milling, preferably by planetary ball milling, specifically:
the planetary ball milling is conducted at a rotational speed of 100 rpm to 500 rpm for 1 h to 12 h under a ball-to-material ratio of (10-500):1.

In some embodiments, under a condition that the lithium metal powder, solid electrolyte, and conductive agent are used as raw materials, a total weight of the raw materials is 100%, the raw materials include:
the lithium metal powder 60% to 95%;
the solid electrolyte 1% to 30%; and
the conductive agent 1% to 10%.

Preferably, the raw materials include:
the lithium metal powder 70% to 90%;
the solid electrolyte 1% to 20%; and
the conductive agent 1% to 10%.

In some embodiments, a mass ratio of the lithium metal powder, the solid electrolyte, and the conductive agent is 85:10:5. In some embodiments, the cold pressing is conducted at 1 MPa to 1 GPa, preferably 100 MPa to 500 MPa.

In some embodiments, the cathode is made of common raw material types in the art, such as a lithium-rich manganese-based cathode material, a layered oxide cathode material, a spinel structure cathode material, and a polyanion cathode material. In some embodiments, the solid electrolyte is a solid electrolyte stable to the lithium metal anode, preferably at least one of hydride and oxide solid electrolytes that do not react with metallic lithium; preferably selected from the group consisting of a PEO-based electrolyte, a boron hydride-based solid electrolyte, a carbon boron hydride-based solid electrolyte, a perovskite-type solid electrolyte, a lithium superion conductor (LISICON)-type solid electrolyte, a sodium superion conductor (NASICON)-type solid electrolyte, a garnet-type solid electrolyte, and a lithium phosphorus oxygen nitrogen (LiPON)-type solid electrolyte.

Compared with the prior art, some embodiments of the present disclosure have the following advantages:

The present disclosure provides a method for preparing a lithium metal powder. A polymer is used as an additive, and the low-temperature brittleness of metallic lithium is utilized. The polymer acts as a grinding aid to reduce the particle size. By subjecting the lithium metal raw material and the polymer to cryogenic ball milling, the median particle size of the metallic lithium powder can be controlled below 500 nm, and the polymer is coated around the lithium particles. By adding ball milling at room temperature after the cryogenic ball milling, and by precisely controlling the process of the ball milling at the room temperature, a lithium metal powder with a median particle size of 10 nm can be prepared. This size is the finest size of metallic lithium powder in the world to date, and greatly increases the specific surface area of metallic lithium powder. The method has the advantages of simple process, wide sources of raw materials and low cost, reduced production cost, high efficiency in preparing nano-scale lithium particles, and short time, and is fully suitable for industrial production requirements. Since it does not need to be heated above the melting point of metallic lithium, it is possible to reduce energy consumption while lowering the requirements for equipment. There is no need for special corrosion-resistant treatment of the equipment, which also improves production safety.

The polymer coating can limit the growth of the nano-lithium powder anode during the charge and discharge, such that it always maintains the nano-scale during the electrochemical cycle; moreover, the polymer coating can inhibit the side reactions between the metallic lithium powder and the liquid electrolyte or solid electrolyte, thereby improving the stability of an electrode-electrolyte interface. However, too high a polymer coating amount can reduce the electronic conductivity of the lithium powder material and also reduce the theoretical capacity of the nano-lithium powder material, which is not conducive to improving its electrochemical performance as the anode of a lithium ion battery. Therefore, the lithium metal anode further prepared using the lithium metal powder as a raw material, as well as the liquid lithium ion battery and solid lithium ion battery further assembled, all show extremely high critical current density for dendrite growth and excellent electroplating/stripping cycle stability. In addition, by further optimizing the electrolyte of liquid lithium ion batteries, the battery performance can be further improved. Under the best conditions, the critical current density of dendrite growth of the assembled liquid lithium ion battery is close to 200 mA/cm², far exceeding the current density requirement of (40-80) mA/cm² specified by VDA. Moreover, the battery also shows a plating/stripping cycle stability of more than 8,000 h, and is expected to be industrially applied.

### BRIEF DESCRIPTION OF THE DRAWINGS

FIG. 1 shows a cryogenic transmission electron microscopy (CryoTEM) image of the lithium metal powder prepared in Example 1;

FIG. 2 shows particle size distribution of the lithium metal powder prepared in Example 1;

FIG. 3 shows an X-ray diffraction (XRD) pattern of the lithium metal powder prepared in Example 1;

FIG. 4 shows a BET argon isothermal adsorption-desorption curve of the lithium metal powder prepared in Example 1;

FIG. 5 shows a voltage-current curve of a liquid electrolyte-based lithium metal powder symmetric battery A assembled with the lithium metal powder prepared in Example 1;

FIG. 6 shows a voltage curve of a liquid electrolyte-based lithium metal powder symmetric battery A assembled with the lithium metal powder prepared in Example 1;

FIG. 7 shows a voltage-current curve of a liquid electrolyte-based lithium metal powder symmetric battery B assembled with the lithium metal powder prepared in Example 1;

FIG. 8 shows a voltage curve of a liquid electrolyte-based lithium metal powder symmetric battery B assembled with the lithium metal powder prepared in Example 1;

FIG. 9 shows a cycle performance curve of a liquid electrolyte-based lithium metal powder full battery assembled with the lithium metal powder prepared in Example 1 at a current density of 20 mA/g (0.1 C);

FIG. 10 shows a voltage-current curve of a solid electrolyte-based lithium metal powder symmetric battery assembled with the lithium metal powder prepared in Example 1;

FIG. 11 shows a voltage curve of a solid electrolyte-based lithium metal powder symmetric battery assembled with the lithium metal powder prepared in Example 1;

FIG. 12 shows a cycle performance curve of a solid electrolyte-based lithium metal powder full battery A assembled with the lithium metal powder prepared in Example 1 at a current density of 12 mA/g (0.1 C);

FIG. 13 shows a scanning electron microscopy (SEM) image of the product prepared in Comparative Example 1;

FIG. 14 shows a BET argon isothermal adsorption-desorption curve of the lithium sheet used in Comparative Example 7;

FIG. 15 shows a voltage-current curve of the liquid electrolyte-based lithium sheet symmetric battery A assembled in Comparative Example 7;

FIG. 16 shows a voltage curve of the liquid electrolyte-based lithium sheet symmetric battery A assembled in Comparative Example 7;

FIG. 17 shows a voltage-current curve of the liquid electrolyte-based lithium sheet symmetric battery B assembled in Comparative Example 7;

FIG. 18 shows a voltage curve of the liquid electrolyte-based lithium sheet symmetric battery B assembled in Comparative Example 7;

FIG. 19 shows a cycle performance curve of the liquid electrolyte-based lithium metal powder full battery assembled in Comparative Example 7 at a current density of 20 mA/g (0.1 C);

FIG. 20 shows a voltage-current curve of the solid electrolyte-based lithium sheet symmetric battery assembled in Comparative Example 7;

FIG. 21 shows a voltage curve of the solid electrolyte-based lithium sheet symmetric battery assembled in Comparative Example 7; and

FIG. 22 shows a cycle performance curve of the solid electrolyte-based lithium sheet full battery A assembled in Comparative Example 7 at a current density of 12 mA/g (0.1 C).

### DETAILED DESCRIPTION OF THE EMBODIMENTS

In order to further understand the present disclosure, the present disclosure is described in detail below in conjunction with the examples and drawings. However, the present disclosure is not limited to these examples, and non-essential improvements and adjustments made by those skilled in the art under the core guiding ideology of the present disclosure still fall within the scope of the present disclosure.

### Example 1

A lithium sheet and PMMA were added into a ball mill tank for cryogenic ball milling in a glove box under an argon atmosphere at a mass ratio of 1:1 and pre-frozen for 20 min, and then a resulting material was subjected to cryogenic ball milling at 20 Hz high frequency and 5 Hz low frequency alternately for 60 min, with each high-frequency ball milling lasting for 5 min and each low-frequency ball milling lasting for 1.5 min each under a ball-to-material ratio of 60:1. An intermediate product obtained after the cryogenic ball milling was scraped out in the glove box under argon atmosphere. The intermediate product was placed in an agate ball mill at a ball-to-material ratio of 150:1, where agate milling balls consisted of 12 mm large balls (50% of a total mass of milling balls, the same below), 6 mm medium balls (40%), and 1 mm small balls (10%), planetary ball milling was conducted at 400 rpm for 6 h, and an obtained lithium metal powder was scraped out in the glove box under argon atmosphere. A yield of the lithium metal powder was tested to be 80%.

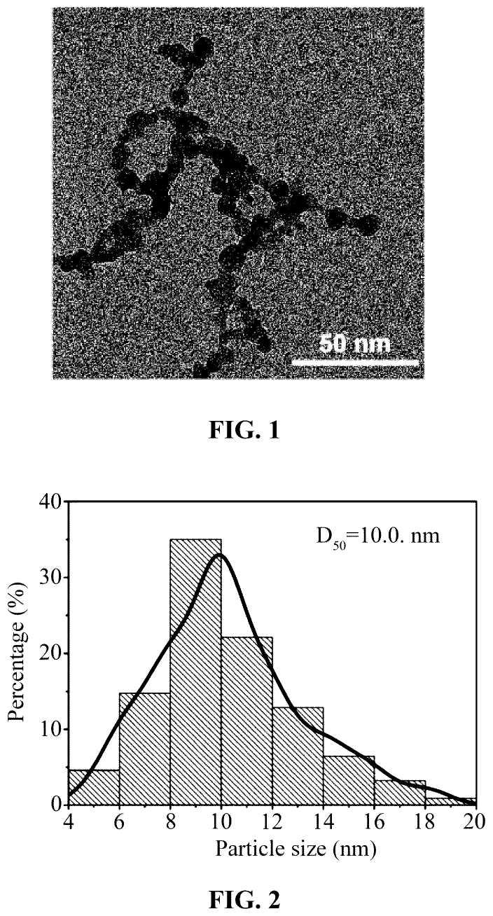

FIG. 1 shows a CryoTEM image of the lithium metal powder prepared in this example. The CryoTEM image shows that the prepared lithium metal powder has a regular shape and is generally spherical.

FIG. 2 shows particle size distribution of the lithium metal powder prepared in this example. The powder has a D50 median diameter of 10.03 nm.

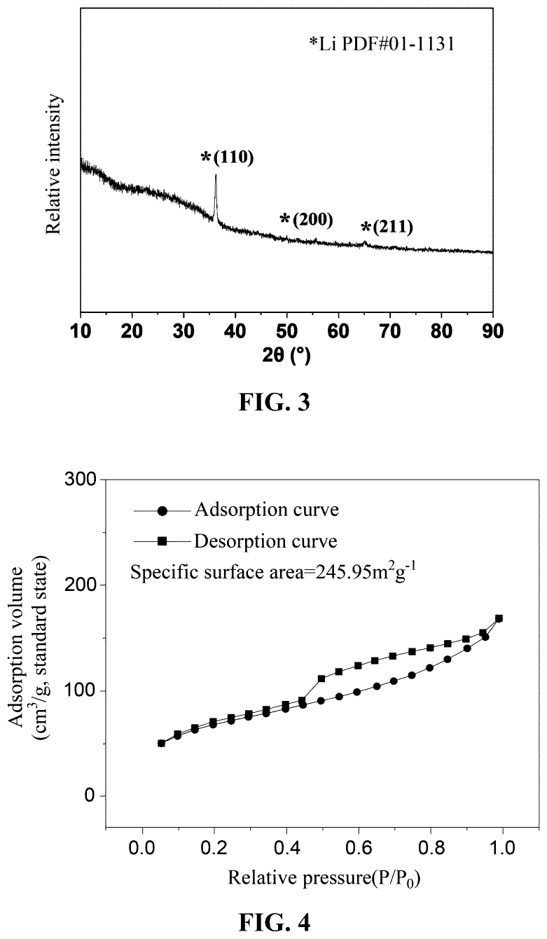

FIG. 3 shows an XRD pattern of the lithium metal powder prepared in this example. The XRD pattern contains characteristic peaks of metallic Li but no impurity peaks of LiO, indicating that lithium does not chemically react with the polymer during the cryogenic ball milling and planetary ball milling.

FIG. 4 shows a BET argon isothermal adsorption-desorption curve of the lithium metal powder prepared in this example. The lithium metal powder has a specific surface area of 245.95 m²/g, which is more than 700 times the specific surface area of lithium sheet (0.33 m²/g, Comparative Example 7).

### Use Example 1: Assembly of Liquid Electrolyte-Based Lithium Metal Powder Symmetric Battery A

The lithium metal powder prepared in the above example was pressed on foamed nickel at 400 MPa, where one piece was used as an electrode and the other piece was used as a counter electrode, a mixed solution of EC, DEC, and DMC (with a volume ratio of 1:1:1) containing 1 mol/L LiPF₆ was used as an electrolyte, and Celgard-2400 was used as a separator to obtain a CR2025 button-type battery, which was recorded as the liquid electrolyte-based lithium metal powder symmetric battery A.

The critical current density of dendrite growth was tested using a battery testing system provided by Neware. The initial current density of lithium plating/stripping was 1 mA/cm², and the time of lithium plating/stripping was 10 min each. The current density was increased after each 1 cycle, and a step size of the current density increase was 1 mA/cm². A current density corresponding to the voltage drop was the critical current density for dendrite growth. The plating/stripping cycle stability was tested using the battery testing system provided by Neware. The current density of lithium plating/stripping was 1 mA/cm², and the time of lithium plating/stripping was 1 h each. When a voltage drop occurred, the cycle was determined to be unstable.

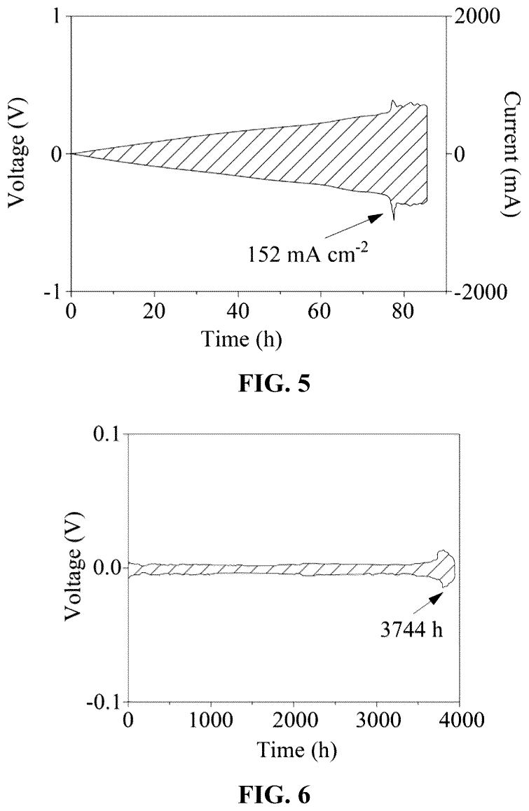

FIG. 5 shows a voltage-current curve of the liquid electrolyte-based lithium metal powder symmetric battery A assembled in the above example. The results show that the critical current density of dendrite growth of the symmetric battery assembled with lithium metal powder prepared in this example is 152 mA/cm², which is nearly 30 times the critical current density of the symmetric battery assembled with lithium sheet (5.79 mA/cm², Comparative Example 7).

FIG. 6 shows a voltage curve of the liquid electrolyte-based lithium metal powder symmetric battery A assembled in the above example. The results show that the cycle stability of the symmetric battery assembled with the lithium metal powder prepared in this example is 3,744 h, which is more than 120 times the cycle stability of the symmetric battery assembled with lithium sheet (30 h, Comparative Example 7).

### Use Example 2: Assembly of Liquid Electrolyte-Based Lithium Metal Powder Symmetric Battery B

The lithium metal powder prepared in the above example was pressed on foamed nickel at 400 MPa, where one piece was used as an electrode and the other piece was used as a counter electrode, a mixed solution of EC, DEC, and DMC (with a volume ratio of 1:1:1) containing 1 mol/L LiPF₆ was used as an electrolyte, 0.5% copper phthalocyanine was added as an additive into the electrolyte, and Celgard-2400 was used as a separator to obtain a CR2025 button-type battery, which was recorded as the liquid electrolyte-based lithium metal powder symmetric battery B. The test conditions for the liquid electrolyte-based lithium metal powder symmetric battery were the same as above.

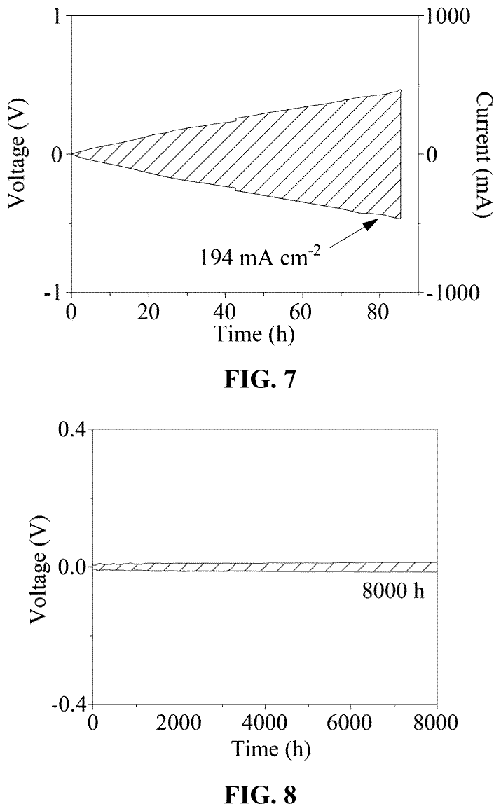

FIG. 7 shows a voltage-current curve of the liquid electrolyte-based lithium metal powder symmetric battery B assembled in the above example. The results show that the critical current density of dendrite growth of the symmetric battery B assembled with lithium metal powder prepared in this example is 194 mA/cm².

FIG. 8 shows a voltage curve of the liquid electrolyte-based lithium metal powder symmetric battery B assembled in the above example. The results show that the cycle stability of the symmetric battery B assembled with the lithium metal powder prepared in this example is over 8,000 h.

### Use Example 3: Assembly of Liquid Electrolyte-Based Lithium Metal Powder Symmetric Battery C

The assembly of the liquid electrolyte-based lithium metal powder symmetric battery was basically the same as that in Use Example 2, except that the additive was replaced with an equal mass of DBBQ. A CR2025 button-type battery was prepared and recorded as the liquid electrolyte-based lithium metal powder symmetric battery C. The test conditions for the liquid electrolyte-based lithium metal powder symmetric battery were the same as above.

After testing, the critical current density of dendrite growth of the symmetric battery C is 160 mA/cm².

### Use Example 4: Assembly of Liquid Electrolyte-Based Lithium Metal Powder Symmetric Battery D

The assembly of the liquid electrolyte-based lithium metal powder symmetric battery was basically the same as that in Use Example 2, except that the additive was replaced with an equal mass of TEMPO. A CR2025 button-type battery was prepared and recorded as the electrolyte-based lithium metal powder symmetric battery D. The test conditions for the liquid electrolyte-based lithium metal powder symmetric battery were the same as above.

After testing, the critical current density of dendrite growth of the symmetric battery D is 170 mA/cm².

### Use Example 5: Assembly of Liquid Electrolyte-Based Lithium Metal Powder Full Battery

The lithium metal powder prepared in this example was pressed onto foamed nickel at 400 MPa as an anode, while a lithium-rich manganese oxide having a composition of 0.5Li₂MnO₃-0.5LiNi_{0.33}Co_{0.33}Mn_{0.33}O₂ was used as a cathode. A mixed solution of EC, DEC, and DMC (with a volume ratio of 1:1:1) containing 1 mol/L LiPF₆ was used as an electrolyte, and Celgard-2400 was used as a separator to obtain a CR2025 button-type battery, which was recorded as the liquid electrolyte-based lithium metal powder full battery.

The electrochemical performance was tested using a battery testing system provided by Neware. The test voltage window was 2.0 V to 4.8V, and the electrochemical performance of the battery was tested by constant current charging and discharging.

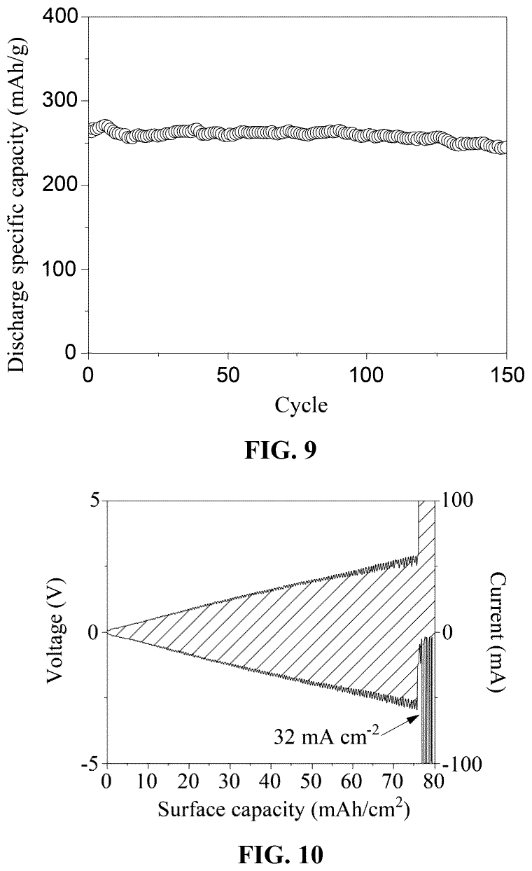

FIG. 9 shows a cycle performance curve of the liquid electrolyte-based lithium metal powder full battery assembled in this example at a current density of 20 mA/g (0.1 C). The initial specific discharge capacity is 263 mAh/g, indicating that the capacity of the material is highly stable. After 150 cycles, the specific discharge capacity is 245 mAh/g, and the capacity retention rate is as high as 93%, which are much higher than the discharge capacity and capacity retention rate of using lithium sheet as anode (the initial specific discharge capacity is 255 mAh/g, the specific discharge capacity after 150 cycles is 210 mAh/g, and the capacity retention rate is 82%, Comparative Example 7).

### Use Example 6: Assembly of Solid Electrolyte-Based Lithium Metal Powder Symmetric Battery

The lithium metal powder prepared in this example, LiBH₄-based solid electrolyte, and vapor-grown carbon fiber (VGCF) conductive agent were added into a ball mill tank for planetary ball milling at a mass ratio of 85:10:5, and the planetary ball milling was conducted at 200 rpm for 3 h to fully mix the above raw materials, and an obtained powder was scraped out in a glove box under argon atmosphere. The obtained powder was pressed onto a current collector at 400 MPa as an anode, where one piece as an electrode and the other piece as a counter electrode. The LiBH₄-based solid electrolyte was used as an electrolyte to obtain a solid mold battery, which was recorded as the solid electrolyte-based lithium metal powder symmetric battery.

The critical current density of dendrite growth was tested using a battery testing system provided by Neware. The initial current density of lithium plating/stripping was 0.1 mA/cm², and the capacity of lithium plating/stripping was 0.3 mA/cm² each. The current density was increased after each 1 cycle, and a step size of the current density increase was 0.2mA/cm² . A current density corresponding to the voltage drop was the critical current density for dendrite growth. The plating/stripping cycle stability was tested using the battery testing system provided by Neware. The current density of lithium plating/stripping was 0.1 mA/cm², and the time of lithium plating/stripping was 1 h each. When a voltage drop occurred, the cycle was determined to be unstable.

FIG. 10 shows a voltage-current curve of the solid electrolyte-based lithium metal powder symmetric battery assembled in this example. The results show that the critical current density of dendrite growth of the symmetric battery assembled in this example is 32mA/cm 2 , which is nearly 80 times the critical current density of the solid electrolyte-based lithium metal powder symmetric battery assembled with lithium sheet (0.38 mA/cm², Comparative Example 7).

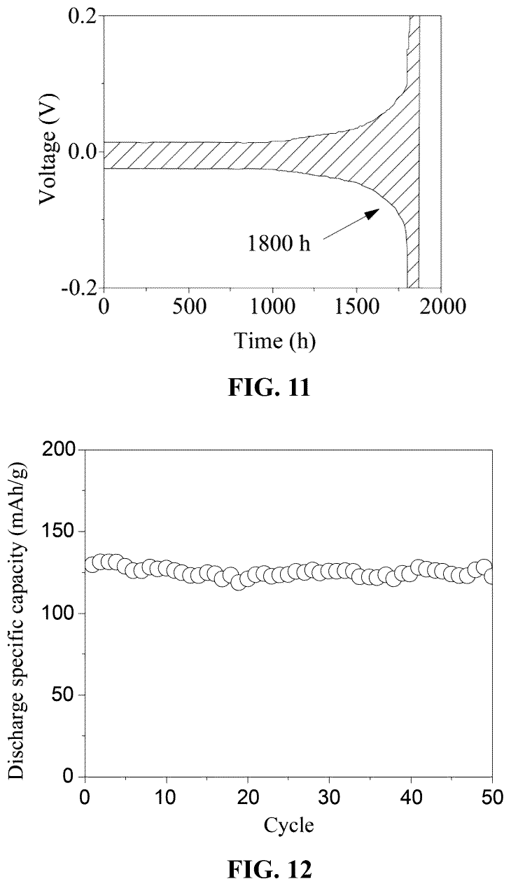

FIG. 11 shows a voltage curve of the solid electrolyte-based lithium metal powder symmetric battery assembled in the above example. The cycle stability exceeds 1,800 h, which is 180 times that of the solid electrolyte-based lithium metal powder symmetric battery assembled with lithium sheet (10 h, Comparative Example 7).

### Use Example 7: Assembly of Solid Electrolyte-Based Lithium Metal Powder Full Battery A

The lithium metal powder prepared in this example, LiBH4-based solid electrolyte, and VGCF conductive agent were added into a ball mill tank for planetary ball milling at a mass ratio of 85:10:5, and the planetary ball milling was conducted at 200 rpm for 3 h to fully mix the above raw materials, and an obtained powder was scraped out in a glove box under argon atmosphere. The obtained powder was pressed onto a current collector at 400 MPa as an anode, and LiCoO₂ was used as a cathode, the LiBH₄-based solid electrolyte was used as an electrolyte to obtain a solid mold battery, which was recorded as the solid electrolyte-based lithium metal powder full battery A.

The electrochemical performance was tested using a battery testing system provided by Neware. The test voltage window was 3.0 V to 4.2 V, and the electrochemical performance of the battery was tested by constant current charging and discharging.

FIG. 12 shows a cycle performance curve of solid electrolyte-based lithium metal powder full battery A assembled in this example at a current density of 12 mA/g (0.1 C). The initial specific discharge capacity is 129 mAh/g, indicating that the capacity of the material is highly stable. After 50 cycles, the specific discharge capacity is 123 mAh/g, and the capacity retention rate is as high as 95%, which are much higher than the discharge capacity and capacity retention rate of using lithium sheet as anode (the initial specific discharge capacity is 127 mAh/g, the specific discharge capacity after 50 cycles is 15 mAh/g, and the capacity retention rate is 12%, Comparative Example 7).

### Use Example 8: Assembly of Solid Electrolyte-Based Lithium Metal Powder Full Battery B

The lithium metal powder prepared in this example, LLZTO-based solid electrolyte, and VGCF conductive agent were added into a ball mill tank for planetary ball milling at a mass ratio of 85:10:5, and the planetary ball milling was conducted at 200 rpm for 3 h to fully mix the above raw materials, and an obtained powder was scraped out in a glove box under argon atmosphere. The obtained powder was pressed onto a current collector at 400 MPa as an anode, and LiCoO₂ was used as a cathode, the LLZTO-based solid electrolyte was used as an electrolyte to obtain a solid mold battery, which was recorded as the solid electrolyte-based lithium metal powder full battery B. The test conditions for the solid electrolyte-based lithium metal powder full battery were the same as that in Use Example 7.

After testing, the initial specific discharge capacity of the full battery B is 127 mAh/g, indicating that the capacity of the material is highly stable. After 20 cycles, the specific discharge capacity is 116 mAh/g, and the capacity retention rate is as high as 91%.

### Example 2

A process for preparing a lithium metal powder was substantially the same as that in Example 1, except that the PMMA was replaced with an equal mass of PP.

Morphological characterization shows that the lithium metal powder prepared in this example has a regular shape and is generally spherical. The powder has a median particle size D50 of 10 nm.

### Example 3

A process for preparing a lithium metal powder was substantially the same as that in Example 1, except that the PMMA was replaced with an equal mass of SBS.

Morphological characterization shows that the lithium metal powder prepared in this example has a regular shape and is generally spherical. The powder has a median particle size D50 of 10 nm.

Examples 1 to 3 verify that the use of polymer as an additive in the present disclosure to grind metallic lithium into small-sized lithium powder is universal.

### Example 4

A lithium sheet and PMMA were added into a ball mill tank for cryogenic ball milling in a glove box under an argon atmosphere at a mass ratio of 1:1 and pre-frozen for 20 min, and then subjected a resulting mixture to cryogenic ball milling at 20 Hz high frequency and 5 Hz low frequency alternately for 60 min, with each high-frequency ball milling lasting for 5 min and each low-frequency ball milling lasting for 1.5 min each under a ball-to-material ratio of 60:1. A product obtained after the cryogenic ball milling was scraped out in the glove box under argon atmosphere.

Morphological characterization shows that the lithium metal powder prepared in this example has a regular shape and is generally spherical. The powder has a median particle size D50 of 101.19 nm and a specific surface area of 133.21 m²/g.

Using the same assembly process and test conditions as those of Use Example 1 in Example 1, the critical current density of dendrite growth of the liquid assembled electrolyte-based lithium metal powder symmetric battery A is 88.43 mA/cm², with a cycle stability exceeding 2,000 h.

### Example 5

A preparation process was basically the same as that in Example 4, except that the ball-to-material ratio for the cryogenic ball milling was replaced with 10:1.

Morphological characterization shows that the lithium metal powder prepared in this example has a regular shape and is generally spherical. The powder has a median particle size D50 of 300 nm.

### Example 6

A preparation process was basically the same as that in Example 4, except that the ball-to-material ratio for the cryogenic ball milling was replaced with 100:1.

Morphological characterization shows that the lithium metal powder prepared in this example has a regular shape and is generally spherical. The powder has a median particle size D50 of 200 nm.

### Example 7

A preparation process was basically the same as that in Example 1, except that the ball-to-material ratio for the planetary ball milling was replaced with 50:1.

Morphological characterization shows that the lithium metal powder prepared in this example has a regular shape and is generally spherical. The powder has a median particle size D50 of 50 nm.

### Example 8

A preparation process was basically the same as that in Example 1, except that the ball-to-material ratio for the planetary ball milling was replaced with 200:1.

Morphological characterization shows that the lithium metal powder prepared in this example has a regular shape and is generally spherical. The powder has a median particle size D50 of 80 nm.

### Example 9

A preparation process was basically the same as that in Example 1, except that an inert solvent n-hexane was additionally added during the planetary ball milling, at 80% of a volume of the ball mill tank.

After testing, the lithium metal powder prepared in this example has a median particle size D50 of 10 nm and a yield of 99%.

### Comparative Example 1

A process for preparing a lithium metal powder was substantially the same as that in Example 1, except that the PMMA was replaced with an equal mass of polyformaldehyde.

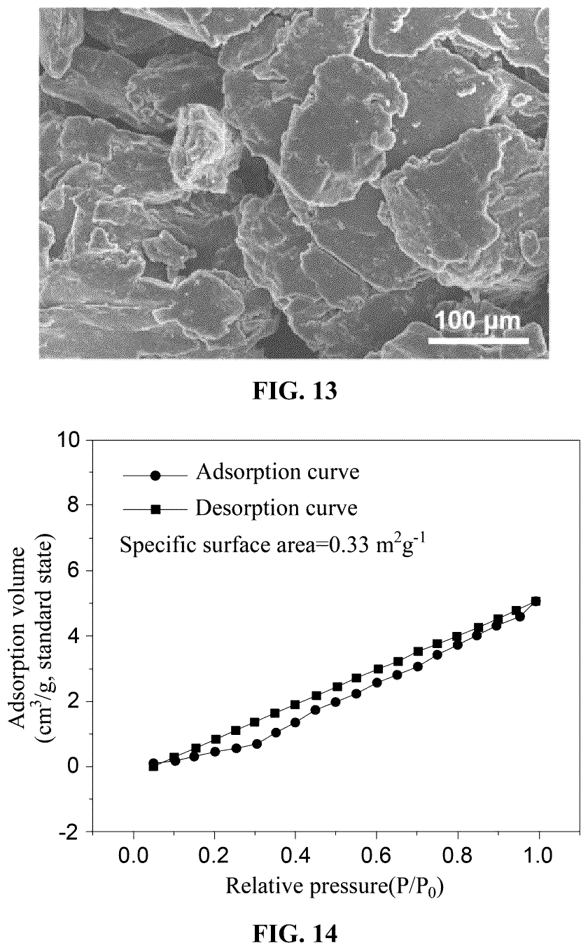

The results show that the lithium sheet could not be ground apart, and the obtained lithium is agglomerated lamellar lithium, with a SEM image shown in FIG. 13.

### Comparative Example 2

A process for preparing a lithium metal powder was substantially the same as that in Example 1, except that the PMMA was replaced with an equal mass of polyethylene.

The results show that the lithium sheet could not be ground apart, and the obtained lithium is agglomerated lamellar lithium.

### Comparative Example 3

A process for preparing a lithium metal powder was substantially the same as that in Example 1, except that the PMMA was replaced with an equal mass of Teflon.

The results show that the lithium sheet could not be ground apart, and the obtained lithium is agglomerated lamellar lithium.

### Comparative Example 4

A process for preparing a lithium metal powder was substantially the same as that in Example 1, except that the PMMA was replaced with an equal mass of ionic liquid, tributyl (methyl ether) phosphine (the ionic liquid was pretreated by heating at 150° C. for 1 h).

The results show that the lithium metal powder finally prepared in this comparative example has a median particle size D50 of only 500 nm.

### Comparative Example 5

A process for preparing a lithium metal powder was substantially the same as that in Example 1, except that the planetary ball milling was conducted by using stainless steel ball mill tank and milling balls.

The results show that the lithium metal agglomerates and fine lithium metal powder could not be obtained.

### Comparative Example 6

A process for preparing a lithium metal powder was substantially the same as that in Example 1, except that the ball-to-material ratio for the planetary ball milling was replaced with 300:1.

The results show that the lithium metal powder prepared in this comparative example has a median particle size D50 of 150 nm. Moreover, silicon dioxide impurities are introduced.

### Comparative Example 7

Commercially available lithium sheets (manufacturer, brand, thickness) were directly used as electrodes, and liquid symmetric batteries, liquid full batteries, solid symmetric batteries, and solid full batteries were assembled according to the method in Example 1. The performance of the above batteries was tested using the same method.

FIG. 14 shows a BET argon isothermal adsorption-desorption curve of the lithium sheet used in this comparative example, and specific surface area of the lithium sheet is only 0.33 m²/g. The value is significantly lower than that in Example 1.

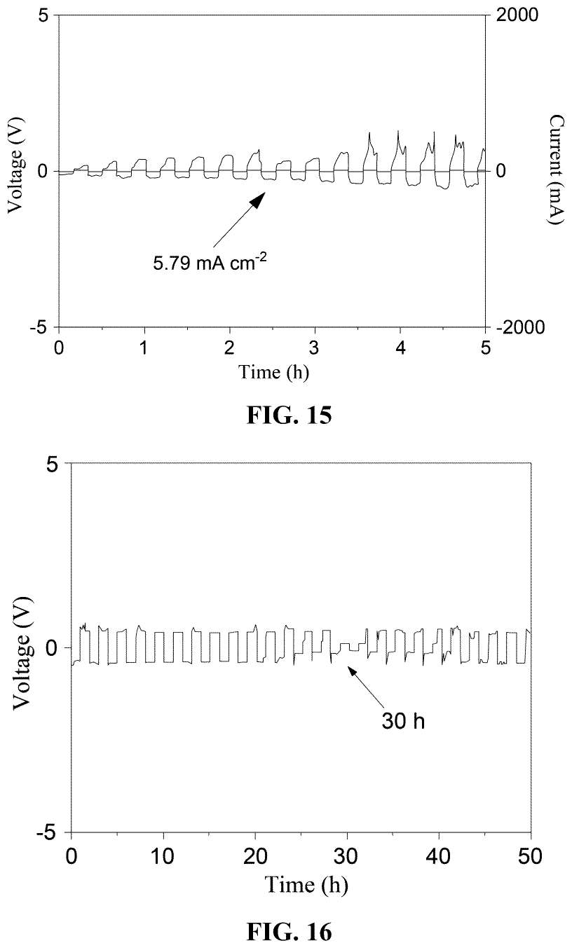

FIG. 15 shows a voltage-current curve of the liquid electrolyte-based lithium sheet symmetric battery A assembled in this comparative example. The critical current density of the lithium sheet is only 5.79 mA/cm². The value is significantly lower than that in Example 1.

FIG. 16 shows a voltage curve of the liquid electrolyte-based lithium sheet symmetric battery A assembled in this comparative example. The cycling stability of the lithium sheet is only 30 h. The value is significantly lower than that in Example 1.

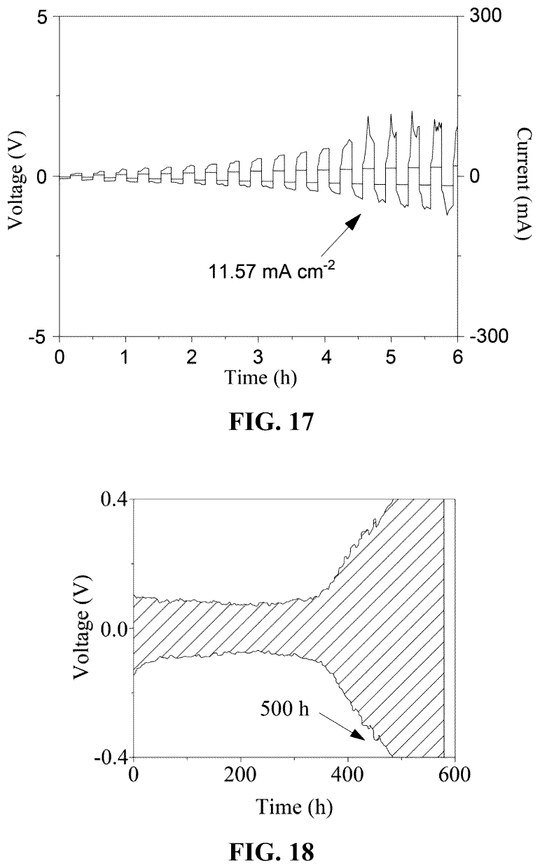

FIG. 17 shows a voltage-current curve of the liquid electrolyte-based lithium sheet symmetric battery B (0.5 wt % copper phthalocyanine was added to the electrolyte as an additive) assembled in this comparative example. The critical current density of the lithium sheet is only 11.57 mA/cm². The value is significantly lower than that in Example 1.

FIG. 18 shows a voltage curve of the liquid electrolyte-based lithium sheet symmetric battery B assembled in this comparative example. The cycling stability of the lithium sheet is only 500 h. The value is significantly lower than that in Example 1.

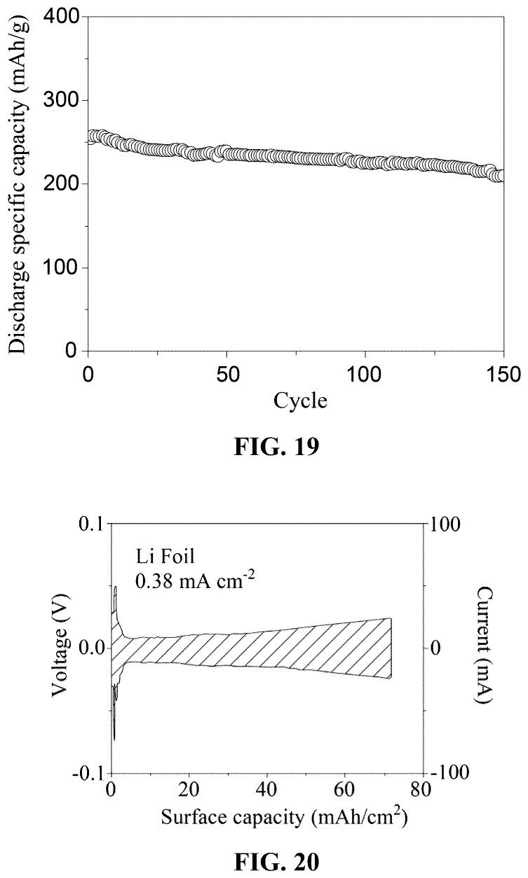

FIG. 19 shows a cycle performance curve of the liquid electrolyte-based lithium metal powder full battery assembled in this comparative example at a current density of 20 mA/g (0.1 C). The initial specific discharge capacity of the lithium sheet as the anode is 255 mAh/g, and the specific discharge capacity after 150 cycles is 210 mAh/g, with a capacity retention rate of only 82%. The value is significantly lower than that in Example 1.

FIG. 20 shows a voltage-current curve of the solid electrolyte-based lithium sheet symmetric battery assembled in this comparative example. The critical current density of the lithium sheet is only 0.38 mA/cm². The value is significantly lower than that in Example 1.

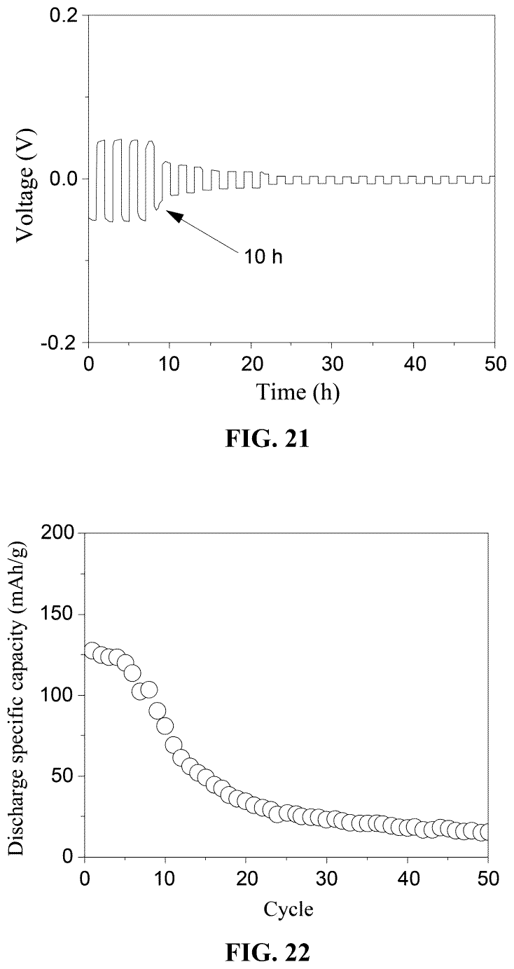

FIG. 21 shows a voltage curve of the solid electrolyte-based lithium sheet symmetric battery assembled in this comparative example. The cycling stability of the lithium sheet is only 10 h. The value is significantly lower than that in Example 1.

FIG. 22 shows a cycle performance curve of the solid electrolyte-based lithium sheet full battery A assembled in this comparative example at a current density of 12 mA/g (0.1 C). The initial specific discharge capacity of the lithium sheet as the anode is 127 mAh/g, and the specific discharge capacity after 50 cycles is 15 mAh/g, with a capacity retention rate of only 12%. The value is significantly lower than that in Example 1.

The above description is only a specific embodiment of the present disclosure, but the scope of the present disclosure is not limited thereto. The above specific examples are used to illustrate the present disclosure, which is only used to help understand the present disclosure and is not used to limit the present disclosure. Those skilled in the art to which the present disclosure belongs may also make some simple deductions, modifications, substitutions, or combinations based on the concepts of the present disclosure. These deductions, modifications, substitutions, or combinations also fall within the scope of the claims of the present disclosure.

1. A method for preparing a lithium metal powder, comprising:
mixing a lithium metal raw material and a polymer additive to obtain a mixture, and subjecting the mixture to cryogenic ball milling under an inert gas atmosphere; wherein the polymer additive does not react with the lithium metal raw material, and has a Rockwell hardness of 70 to 110.

2. The method for preparing the lithium metal powder of claim 1, wherein a mass ratio of the lithium metal raw material to the polymer additive is in a range of 1: (0.5-2.0).

3. The method for preparing the lithium metal powder of claim 1, wherein the cryogenic ball milling copmrises:
pre-freezing the mixture of the lithium metal raw material and the polymer additive in a cryogenic medium, and then alternately conducting high-frequency ball milling or high-speed ball milling and low-frequency ball milling or low-speed ball milling in sequence until the cryogenic ball milling is completed; wherein
the cryogenic medium is at least one selected from the group consisting of liquid nitrogen, liquid helium, and liquid argon;
the pre-freezing is conducted for 10 minutes to 60 minutes;
under a condition that the cryogenic ball milling is conducted by vibration ball milling, the high-frequency ball milling is conducted at a frequency of 15 Hz (Hertz) to 25 Hz for 2 minutes to 15 minutes; and the low-frequency ball milling is conducted at a frequency of 1 Hz to 10 Hz for 1 minute to 10 minutes;
under a condition that the cryogenic ball milling is conducted by planetary ball milling, the high-speed ball milling is conducted at a rotational speed of 250 rpm to 600 rpm for 5 minutes to 60 minutes; and the low-speed ball milling is conducted at a rotational speed of 30 rpm to 250 rpm for 1 minute to 20 minutes;
the cryogenic ball milling is conducted for 30 minutes to 90 minutes in total; and
the cryogenic ball milling is conducted at a ball-to-material ratio of (10-100):1.

4. The method for preparing the lithium metal powder of claim 3, wherein under a condition that the pre-freezing is conducted for 20 minutes, and the high-frequency ball milling at a frequency of 20 Hz and the low-frequency ball milling at a frequency of 5 Hz are alternately conducted for 60 minutes in total each at a ball-to-material ratio of 60:1, the lithium metal powder has a median particle size of 100 nanometers.

5. The method for preparing the lithium metal powder of claim 1, wherein the polymer additive is at least one selected from the group consisting of polymethyl methacrylate (PMMA), polypropylene (PP), styrene-butadiene-styrene block copolymer, acrylonitrile-butadiene-styrene copolymer, polycarbonate (PC), polyamide 66, and polyamide 6.

6. The method for preparing the lithium metal powder of claim 1, wherein the method further comprises subjecting a product obtained after the cryogenic ball milling to ball milling at room temperature after the cryogenic ball milling is completed.

7. The method for preparing the lithium metal powder of claim 6, wherein the ball milling at the room temperature is conducted by planetary ball milling at a rotational speed of 100 rpm to 400 rpm for 3 hours to 30 hours under a ball-to-material ratio of (50-200):1; and a ball mill tank and milling balls for the planetary ball milling each are made of agate.

8. The method for preparing the lithium metal powder of claim 7, wherein the milling balls used in the ball milling at the room temperature comprise the following balls in percentage by mass: 50% to 75% of large balls, 20% to 40% of medium balls, and small balls as a balance; and the large balls each have a diameter of 8 millmetres to 14 millimetres, the medium balls each have a diameter of 1.5 millimetres to 6.0 millimetres, and the small balls each have a diameter of 0.5 millimetres to 1.5 millimetres.

9. The method for preparing the lithium metal powder of claim 6, wherein an inert solvent is further added during the ball milling at the room temperature, and the inert solvent does not react with the lithium metal raw material or the polymer additive; and the inert solvent is at least one selected from the group consisting of n-hexane, cyclohexane, n-heptane, n-octane, and benzene.

10. A lithium metal powder prepared by the method of any one of claim 1, wherein the lithium metal powder has a median particle size less than or equal to 500 nanometres.

11. A lithium metal anode, comprising a current collector and an anode active material layer deposited on the current collector, wherein the anode active material layer comprises the lithium metal powder of claim 10.

12. A liquid electrolyte-based lithium ion battery, comprising a cathode, an anode, and an electrolyte, wherein
the anode is the lithium metal anode of claim 11; and
the electrolyte comprises a lithium salt and a non-aqueous solvent.

13. The liquid electrolyte-based lithium ion battery of claim 12, wherein the electrolyte further comprises an electrolyte additive; and
the electrolyte additive is at least one selected from the group consisting of fluoroethylene carbonate (FEC), phthalocyanine, a phthalocyanine metal complex, an I₂ elementary substance, triethylsulfonium iodide, 2,2,6,6-tetramethylpiperidinooxy (TEMPO), and 2,5-di-tert-butyl-1,4-benzoquinone (DBBQ).

14. The liquid electrolyte-based lithium ion battery of claim 12, wherein the electrolyte additive has a mass fraction of 0.01% to 10.00%.

15. The liquid electrolyte-based lithium ion battery of claim 12, wherein the anode is prepared by a process comprising: cold pressing the lithium metal powder onto the current collector; and
the cold pressing is conducted at a pressure of 1 MPa (megapascal) to 1 GPa (gigapascal).

16. A solid electrolyte-based lithium ion battery, comprising a cathode, an anode, and a solid electrolyte, wherein the anode is the lithium metal anode of claim 11.

17. The solid electrolyte-based lithium ion battery of claim 16, wherein the anode is prepared by a process comprising: mixing raw materials comprising the lithium metal powder, the solid electrolyte, and a conductive agent, and then subjecting a resulting mixture to cold pressing to obtain the anode; and
the cold pressing is conducted at a pressure of 1 MPa to 1 GPa.

18. The solid electrolyte-based lithium ion battery of claim 17, wherein the mixing is conducted by ball milling; and
the ball milling is conducted by planetary ball milling at a rotational speed of 100 rpm to 500 rpm for 1 hour to 12 hours under a ball-to-material ratio of (10-500):1.

19. The solid electrolyte-based lithium ion battery of claim 17, wherein, based on a total weight of the lithium metal powder, the solid electrolyte, and the conductive agent as 100%, the raw materials comprise:
60% to 95% of the lithium metal powder,
1% to 30% of the solid electrolyte, and
1% to 10% of the conductive agent.
